(19) United States
(12) Patent Application Publication
(10) Pub. No.: US 2016/0239901 A1
(43) Pub. Date: Aug. 18, 2016

(54) FOOD INVENTORY AND PURCHASING TOOL

(71) Applicant: HON HAI PRECISION INDUSTRY CO., LTD., New Taipei (TW)

(72) Inventors: SHIANG-HUI WEI, New Taipei (TW); TAY-YANG LIN, New Taipei (TW); SHIH-FENG LU, New Taipei (TW)

(21) Appl. No.: 14/691,186

(22) Filed: Apr. 20, 2015

(30) Foreign Application Priority Data
Feb. 12, 2015 (TW) 104104859

(51) Int. Cl. G06Q 30/06; G06Q 10/08

(52) U.S. Cl. CPC G06Q 30/0631; G06Q 10/08; G06Q 30/0641; G06Q 30/0633

(57) ABSTRACT

A food inventory and purchasing tool includes a food inventory capturing module, a menu interface module and a required purchase determining module. The food inventory capturing module captures inventory stored in food storage areas of a user The menu interface module obtains a proposed menu of a planned user meal. The proposed menu includes ingredients and quantities required to prepare the planned user meal. The required purchase determining module determines ingredients required to be purchased based, at least in part upon, the identified inventory of food stored in the user food storage areas and the obtained proposed menu of the planned user meal.

### CROSS-REFERENCE TO RELATED APPLICATIONS

This application claims priority to Taiwan Patent Application No. 104104859, filed on Feb. 12, 2015, the contents of which are incorporated by reference herein.

### FIELD

The subject matter herein relates to refrigerators, especially relates to a food inventory and purchasing tool.

### BACKGROUND

Before going to the supermarket to buy food, people make a list of what food should be bought according to the food in a refrigerator, the non-refrigerated food in the house and a planned menu.

### BRIEF DESCRIPTION OF THE DRAWINGS

Implementations of the present technology will now be described, by way of example only, with reference to the attached figures.

FIG. 1 is a block diagram of an embodiment of a refrigerator.

FIG. 2 is a block diagram of another embodiment of a refrigerator.

FIG. 3 is a block diagram of a food inventory capturing module of the intelligent refrigerator in FIGS. 1 and 2.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, components have not been described in detail so as not to obscure the related relevant feature being described. The description is not to be considered as limiting the scope of the embodiments described herein.

The term “comprising” means “including, but not necessarily limited to”; it specifically indicates open-ended inclusion or membership in a so-described combination, group, series, and the like.

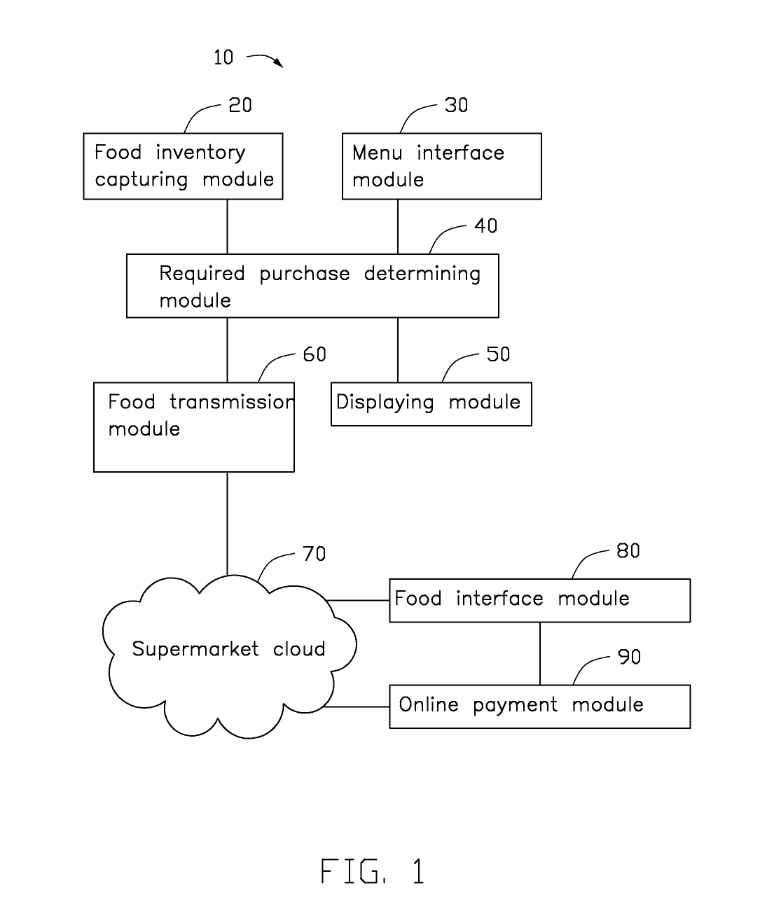

FIG. 1 illustrates a refrigerator 10 includes a food inventory capturing module 20, a menu interface module 30 and a required purchase determining module 40. The food inventory capturing module 20 is configured to capture the inventory of food in the refrigerator 10. The menu interface module 30 is configured to obtain a user menu. The user menu includes food the user plans to eat. In the embodiment, the menu interface module 30 is a touch screen interface device. The required purchase determining module 40 is configured to determine ingredient purchase information according to ingredients of the food in the refrigerator 10 and the obtained user menu. The ingredient purchase information includes information of ingredients that need to be bought, such as names and quantity of the ingredient needed to be bought.

The refrigerator 10 further includes a displaying module 50 and a food transmission module 60. The displaying module 50 is configured to display the purchase information of the ingredients needed to be bought. In the embodiment, the food transmission module 60 communicates with a supermarket cloud 70. The food transmission module 60 is configured to transmit the ingredient purchase information and home address information of a user to the supermarket cloud 70. The supermarket cloud 70 is configured to determine supermarkets providing the ingredients needed nearby the home of the user, and transmit the determined supermarket and price information of the ingredient needed to be bought to the refrigerator 10. The displaying module 50 is further configured to display the determined supermarket and price information of the ingredient.

The refrigerator 10 further includes a food interface module 80. The food interface module 80 is configured to determine the supermarket the user selects and transmit the selected supermarket information to the supermarket cloud 70. The refrigerator 10 further includes an online payment module 90. The online payment module 90 is configured to pay for the ingredient needed at the selected supermarket to an cash account of the selected supermarket. The supermarket cloud 70 is further configured to transmit a delivery time of the ingredient to the refrigerator 10 according to a distance between the home address information of the user and the selected supermarket. The displaying module 80 is further configured to display the delivery time of the ingredient.

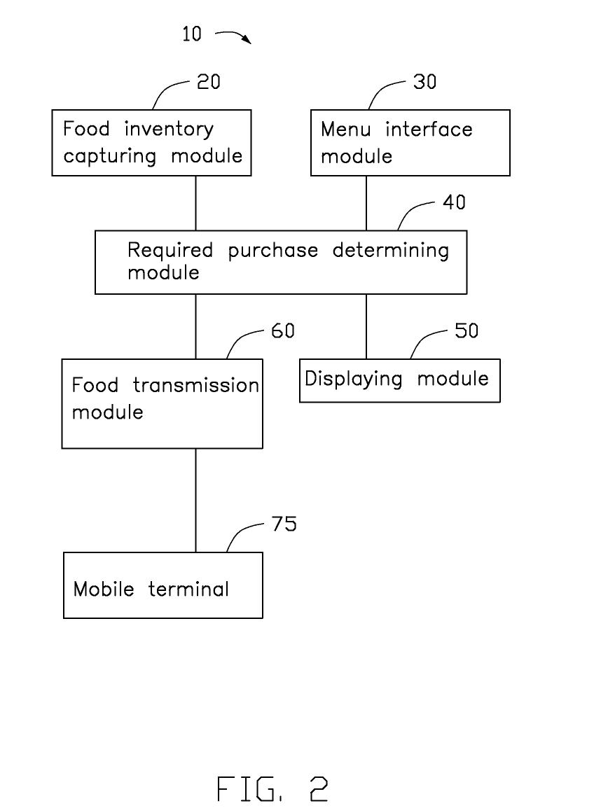

FIG. 2 illustrates, in another embodiment, the food transmission module 60 communicates with a mobile terminal 75, for example, a mobile phone. The food transmission module 60 transmits the ingredient purchase information to the mobile terminal 75. When the user goes to supermarket, the user can buy ingredients according to the ingredient purchase information in the mobile terminal 75.

In the embodiment, the food inventory capturing module 20 is an input module. The user inputs the information of ingredient in the refrigerator 10 by the input module. The input information of ingredient includes names, quantity and expiration dates of the ingredient.

In another embodiment, the food inventory capturing module 20 is an ingredient identifying module positioned in the refrigerator 10. The ingredient identifying module captures and identifies images of the ingredient to obtain the information of the ingredient in the refrigerator 10.

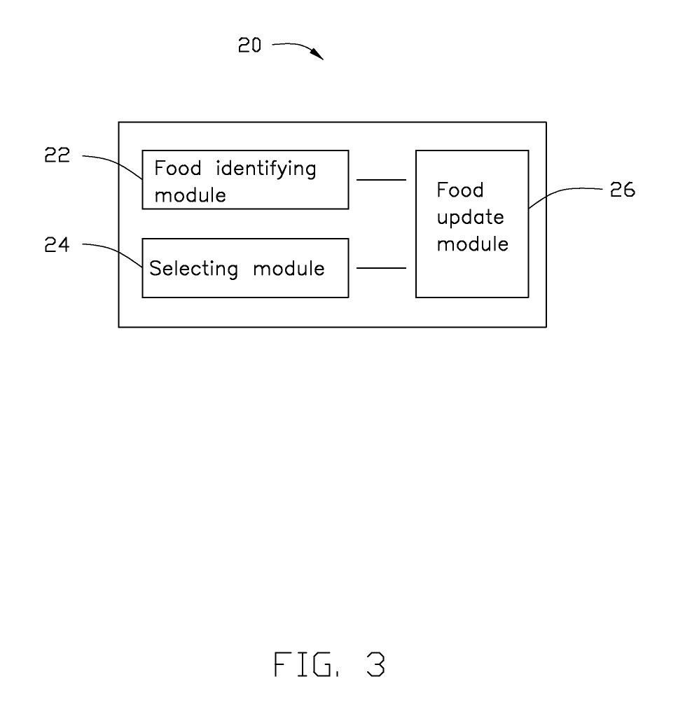

FIG. 3 illustrates that the food inventory capturing module 20 includes a food identifying module 22, a selecting module 24 and a food update module 26. The food identifying module 22 is positioned on a shell of a door of the refrigerator 10. The food identifying module 22 captures images in a preset scope to obtain ingredient information. The selecting module 24 is selected by the user to determine if ingredients need to be stored or taken out. The food update module 26 updates information of ingredients in the refrigerator 10 according to the obtained ingredient information and the selection of the user.

The menu interface module 30 displays a menu list according to an operation and obtains the user menu according to a selection on the menu list. The menu interface module 30 further displays a suggested menu according to the information of the ingredients in the refrigerator 10. The menu interface module 30 further displays the ingredient nearing its expiration date according to the information of the ingredient in the refrigerator.

The embodiments shown and described above are only examples. Even though numerous characteristics and advantages of the present technology have been set forth in the foregoing description, together with details of the structure and function of the present disclosure, the disclosure is illustrative only, and changes may be made in the details, including in matters of shape, size, and arrangement of the parts within the principles of the present disclosure, up to and including the full extent established by the broad general meaning of the terms used in the claims.

What is claimed is:

1. A food inventory tool comprising:
a food inventory capturing module configured to capture inventory of food stored in a refrigerator;
a menu interface module configured to obtain a proposed menu of a planned user meal, the proposed menu including ingredients and quantities required to prepare the planned user meal; and
a required purchase determining module configured to determine ingredients required to be purchased based, at least in part upon, the identified inventory of food stored in the refrigerator and the obtained proposed menu of the planned user meal.

2. The food inventory tool as claimed in claim 1, wherein the food inventory capturing module is positioned in the refrigerator, the food inventory capturing module captures and identifies images of the food to obtain the inventory in the refrigerator.

3. The food inventory tool as claimed in claim 1, wherein the menu interface module displays a menu list according to a user's operation and obtains the planned user meal according to a user's selection on the menu list.

4. The food inventory tool as claimed in claim 1, wherein the menu interface module further displays a suggestion menu according to the information of the ingredient in the refrigerator.

5. The food inventory tool as claimed in claim 1, wherein the inventory of food stored in a refrigerator comprises expiration dates of the food, the menu interface module further displays the food nearing its expiration date according to the food in the refrigerator.

6. The food inventory tool claimed in claim 1, further comprising:
a food transmission module communicating with a mobile terminal, the food transmission module configured to transmit the ingredients required to be purchased to the mobile terminal.

7. The food inventory tool as claimed in claim 6, wherein the mobile terminal is a mobile phone.

8. The food inventory tool as claimed in claim 1, further comprising:
a food transmission module communicating with a supermarket cloud, the food transmission module configured to transmit the ingredients required to be purchased and user's home address information to the supermarket cloud.

9. The food inventory tool as claimed in claim 8, further comprising:
a food interface module configured to determine the supermarket the user selects according to a user's operation and transmit the selected supermarket information to the supermarket cloud according to determined supermarket and price information of the ingredients required to be purchased transmitted from the supermarket cloud.

10. The food inventory tool as claimed in claim 1, further comprising:
a displaying module configured to display the ingredients required to be purchased.

11. A food inventory and purchasing tool comprising:
a food inventory capturing module configured to capture inventory stored in food storage areas of a user;
a menu interface module configured to obtain a proposed menu of a planned user meal, the proposed menu including ingredients and quantities required to prepare the planned user meal; and
a required purchase determining module configured to determine ingredients required to be purchased based, at least in part upon, the identified inventory of food stored in the user food storage areas and the obtained proposed menu of the planned user meal.

12. The food inventory and purchasing tool as claimed in claim 11, wherein the a food inventory capturing module captures and identifies images of the food in food storage areas of the user to obtain inventory.

13. The food inventory and purchasing tool as claimed in claim 11, wherein the menu interface module displays a food list according to a user's operation and obtains the planned user meal according to a user's selection on the food list.

14. The food inventory and purchasing tool as claimed in claim 11, wherein the menu interface module further displays a suggestion food according to the information of the ingredient in the refrigerator.

15. The food inventory and purchasing tool as claimed in claim 11, wherein the inventory stored in food storage areas of the user comprises expiration dates of the ingredient, the menu interface module further displays the food nearing its expiration date.

16. The food inventory and purchasing tool claimed in claim 11, further comprising:
a food transmission module communicating with a mobile terminal, the food transmission module configured to transmit the ingredients required to be purchased to the mobile terminal.

17. The food inventory and purchasing tool as claimed in claim 16, wherein the mobile terminal is a mobile phone.

18. The food inventory and purchasing tool as claimed in claim 11, further comprising:
a food transmission module communicating with a supermarket cloud, the food transmission module configured to transmit the ingredients required to be purchased and user's home address information to the supermarket cloud.

19. The food inventory and purchasing tool as claimed in claim 18, further comprising:
a food interface module configured to determine the supermarket the user selects according to a user's operation and transmit the selected supermarket information to the supermarket cloud according to determined supermarket and price information of the ingredients required to be purchased transmitted from the supermarket cloud.

20. The food inventory and purchasing tool as claimed in claim 11, further comprising:
a displaying module configured to display the ingredients required to be purchased.
